(19) United States
(12) Patent Application Publication
(10) Pub. No.: US 2026/0086965 A1
(43) Pub. Date: Mar. 26, 2026

(54) METHOD AND APPARATUS FOR HARDWARE RESOURCE SHARING IN A DIRECT MEMORY ACCESS CONTROLLER

(71) Applicant: Arm Limited, Cambridge (GB)

(72) Inventors: Tamás Retkes, Budapest (HU); Andras Csuzi, Pecs (HU); Seow Chuan Lim, Letchworth Garden City (GB); Dávid Velki, Ják (HU)

(73) Assignee: Arm Limited, Cambridge (GB)

(21) Appl. No.: 19/333,770

(22) Filed: Sep. 19, 2025

(30) Foreign Application Priority Data
Sep. 26, 2024 (GB) 2414169.9

(51) Int. Cl. G06F 13/28; G06F 9/30; G06F 9/448

(52) U.S. Cl. CPC G06F 13/287; G06F 9/30101; G06F 9/4498

(57) ABSTRACT

A direct memory access controller (DMAC) includes virtual channels, physical channels and a context manager. A virtual channel is configured to generate a flow control signal for execution of a direct memory access (DMA) command. A physical channel includes read and write control logic to initiate, responsive to the flow control signal, transfer of data from source device to a destination device in accordance with the DMA command. The context manager includes allocation logic configured to arbitrate between allocation requests from the virtual channels and allocate a physical channel to a selected virtual channel and routing logic configured to route a flow control signal from the selected virtual channel to the allocated physical channel and to route a status signal between the allocated physical channel and the selected virtual channel.

### BACKGROUND

In a data processing system, a Direct Memory Access (DMA) controller enables the movement of blocks of data from peripheral to memory, memory to peripheral, or memory to memory without burdening the processor. A DMA controller may include a number of channels. Each DMA channel includes hardware that is programmed to generate one or more addresses (such as memory addresses or addresses of memory-mapped peripherals), and initiate read and write cycles.

When a peripheral device operates at a slow rate (compared to a processor, for example), an associated DMA channel may operate at a small fraction of its maximum capacity resulting in an inefficient use of hardware resources.

### BRIEF DESCRIPTION OF THE DRAWINGS

The accompanying drawings provide visual representations which will be used to describe various representative embodiments more fully and can be used by those skilled in the art to understand better the representative embodiments disclosed and their inherent advantages. In these drawings, like reference numerals identify corresponding or analogous elements.

FIG. 1 is a block diagram of a data processing system that includes a Direct Memory Access Controller (DMAC), in accordance with various representative embodiments.

FIG. 2 is a block diagram of a direct memory access controller (DMAC) in accordance with various representative embodiments.

FIG. 3 is a block diagram of a virtual channel of a DMAC, in accordance with various representative embodiments.

FIG. 4 is a block diagram of a physical channel of a DMAC, in accordance with various representative embodiments.

FIG. 5 is a block diagram of a context manager of a DMAC, in accordance with various representative embodiments.

FIG. 6 is a block diagram of a DMA control logic block, in accordance with various representative embodiments.

FIG. 7 is a block diagram of a data bus interface (BIU) of a DMAC, in accordance with various representative embodiments.

FIG. 8 is a block diagram of a context bus interface (BIU) of a DMAC, in accordance with various representative embodiments.

FIG. 9 is a further block diagram of a physical channel of a DMAC, in accordance with various representative embodiments.

FIG. 10 is a diagrammatic representation of a read and write finite state machine (FSM), in accordance with various representative embodiments.

FIG. 11 is a block diagram of a context manager, in accordance with various representative embodiments.

FIG. 12 is a further block diagram of a context manager, in accordance with various representative embodiments

FIG. 13 is a diagrammatic representation of a context FSM for a physical channel, in accordance with various representative embodiments.

FIG. 14 is a diagrammatic representation of signal flow between virtual and physical channels, in accordance with various representative embodiments.

FIGS. 15A and 15B together constitute a flow chart of a virtual channel control FSM, in accordance with various representative embodiments.

FIG. 16 is an example timing diagram for channel operation, in accordance with various representative embodiments.

FIG. 17 is an example timing diagram for channel operation, in accordance with various representative embodiments.

FIG. 18 is an example timing diagram, in accordance with various representative embodiments.

FIG. 19 is an example timing diagram, in accordance with various representative embodiments.

FIG. 20 is a further example timing diagram, in accordance with various representative embodiments.

### DETAILED DESCRIPTION

The various apparatus and devices described herein provide mechanisms for hardware resource sharing in a Direct Memory Access (DMA) controller.

While this present disclosure is susceptible of embodiment in many different forms, there is shown in the drawings and will herein be described in detail specific embodiments, with the understanding that the embodiments shown and described herein should be considered as providing examples of the principles of the present disclosure and are not intended to limit the present disclosure to the specific embodiments shown and described. In the description below, like reference numerals are used to describe the same, similar or corresponding parts in the several views of the drawings. For simplicity and clarity of illustration, reference numerals may be repeated among the figures to indicate corresponding or analogous elements.

The DMA channels of a DMA controller (DMAC) are the core engines that support data movement functionality. In accordance with the present disclosure, a DMAC structurally divides DMA channels into virtual channels (VCH) and physical channels (PCH). Virtual channels implement the aspects of a data transfer that are unique to each DMA channel, while physical channels consist of logic and resources that are identical for each DMA channel. In particular, one or more physical channels are shared between multiple virtual channels. The DMAC includes a context manager that controls the virtual channel allocation and de-allocation to physical channels. Virtual channels implement the control state machine that manages the DMA channel's lifecycle. The DMA channels can have peripheral trigger ports for autonomous command and flow control between the DMA and the peripherals. Each virtual channel has its own trigger control block which handles the corresponding external trigger interfaces.

From the viewpoint of external software, there are only DMA channels. However, microarchitecturally, DMAC splits channels to VCH/PCH pairs. VCH-X is always a part of channel X and includes a state-machine that tracks and controls the lifecycle of the DMA command the channel is supposed to perform. PCH-Y does not always belong to channel X but may be allocated to channel X or to any of the other DMA channels.

In one embodiment, virtual channels also provide general purpose outputs (GPO) for system level control depending on the configuration.

In one embodiment, the physical channels implement read and write control logic, which may include burst calculation logic and pipelines. They may also implement the command linking logic for reading command descriptors, and based on those, performing the necessary updates to the relevant registers in the PCH and/or VCH or in a context memory. Each physical channel may implement its own context fetch/save logic, as well as the register reload logic which is used by commands that are set to automatically some registers to their initial values.

In one embodiment, the physical channels are connected, via custom DMA transfer interfaces for example, to bus interface units (BIU) that serve as arbiters between physical channels that operate in parallel and generate transfers on their bus interface as requested by the PCHs. A data BIU arbitrates DMA data transfer requests or command descriptor read requests during command linking.

In one embodiment, the data BIU contains the data first-in, first-out (FIFO) buffer that is shared between the PCHs. While a FIFO could be incorporated in each physical channels, locating a FIFO in the data BIU avoids duplication and reduces the amount of logic circuitry.

“Context data” or “channel context” herein refers to any information that resides in a physical channel when it is allocated to a virtual channel and resides in a context memory when the virtual channel does not have a physical channel allocated to it. This includes architectural and microarchitectural data. Software on an external device that programs and uses a DMA channel expects to be able to read or write designated control and status data. This data is termed architectural data. Architectural data is stored in registers that the software writes when it programs the channel and reads when it polls their status. The data stored in the physical channel is part of the context data. Microarchitectural data includes any data in addition to the architectural data that the DMAC uses to implement the architectural behavior seen by an external device. For example, this may include counter values such as trigger block remainder counter values, some initial values, state machine states, error correction code (ECC) sums, etc.

When a given channel is allocated, its PCH context data is in PCH. In deallocated state, the given channel's context data is saved to context memory, and all PCH modules contain other channels' context data.

Part of the context data for each channel (referred to as the channel's context) may be stored in a context memory. This may be an external memory accessed via a context BIU. A channel's context comprises the architectural and microarchitectural information based on which the channel operates and performs DMA transfers. Another part of the channel context may be stored within the DMAC in a VCH register bank. The context stored in the context memory is loaded or fetched into the PCH to which the VCH gets allocated or written back (saved) when the VCH gets de-allocated.

While a single BIU could be shared for DMA data transfers and context data access, the use of separate BIUs reduces the bandwidth impact of moving context data between a PCH and the context memory. In addition, it reduces bus conflicts and allows one physical channel to perform DMA transfers while another is saving or loading context data as a result of re-allocation.

In one embodiment, the DMAC includes a control block that defines additional settings for each channel and select channels security levels. It may also collect global status information and interrupts from the virtual channels for easier management of the whole DMA.

The DMAC may include a low power interface (LPI) control block that provides quiescence capability for clock and handles power control.

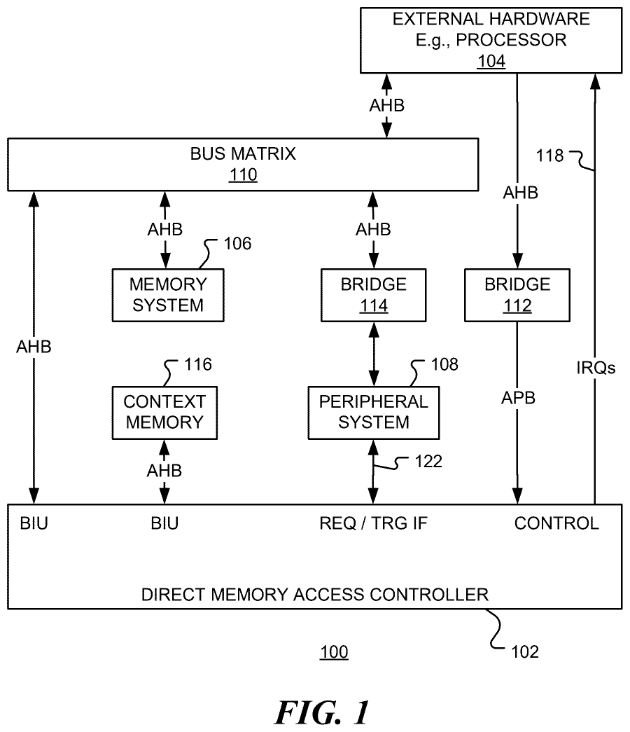

FIG. 1 is a block diagram of a data processing system 100 that includes a Direct Memory Access Controller (DMAC) 102 in accordance with various representative embodiments. In addition to DMAC 102, system 100 includes one or more processors 104, memory system 106, and peripheral system 108. Memory system 106 may include one or memories and associated memory controllers. Peripheral system 108 may include peripheral devices, such as a universal asynchronous receiver-transmitter (UART), serial peripheral interface (SPI), inter-integrated circuit (I2C) port or timer, and other peripheral devices that provide data input or output. DMAC 102 provides fast memory to memory, peripheral to memory, memory to peripheral copy, and peripheral to peripheral capabilities on multiple channels.

In some embodiments, components of data processing system 100 are connected and managed via a bus system such the open standard Advanced Microcontroller Bus Architecture (AMBAR) of Arm Limited. For example, the bus system may include an Advanced High-performance Bus (AHB) for fast, low latency transactions and an Advanced Peripheral Bus (APB) that is highly compact, low power bus used for configuration and low bandwidth traffic. The APB supports low bandwidth transactions used to access configuration registers and low bandwidth data traffic in peripherals. While the DMAC is described below with reference to AHB's and APB's, it should be recognized that other bus architectures may be used without departing from the present disclosure. In the embodiment shown in FIG. 1, bus matrix 110 provides an interconnect between the different components. Bridge 112 bridges between an AHB of processor 104 and an APB of DMAC 102. This link is used to enable processor 104 to control DMAC 102 by writing to configuration registers, for example. Bridge 114 bridges between an AHB of bus matrix 110 and APB's of peripheral devices of peripheral system 108. Context memory 116, such as a random-access memory (RAM), is used to store context data (e.g., logic and memory values) of DMAC 102. In the embodiment shown, this is a dedicated memory, accessed via a dedicated bus. In another embodiment, the context memory is a region in a shared memory, accessed via bus matrix 110.

The completion of transfers by DMAC 102 may be signaled to processor 104 via one or interrupt signal lines 118.

DMAC 102 may include a first bus interface unit (BIU) to access devices of peripheral system 108 via the AHB bus architecture. Further, link 122 may be provided between DMAC 102 and peripherals of peripheral system 108 to enable transmission of requests and triggers.

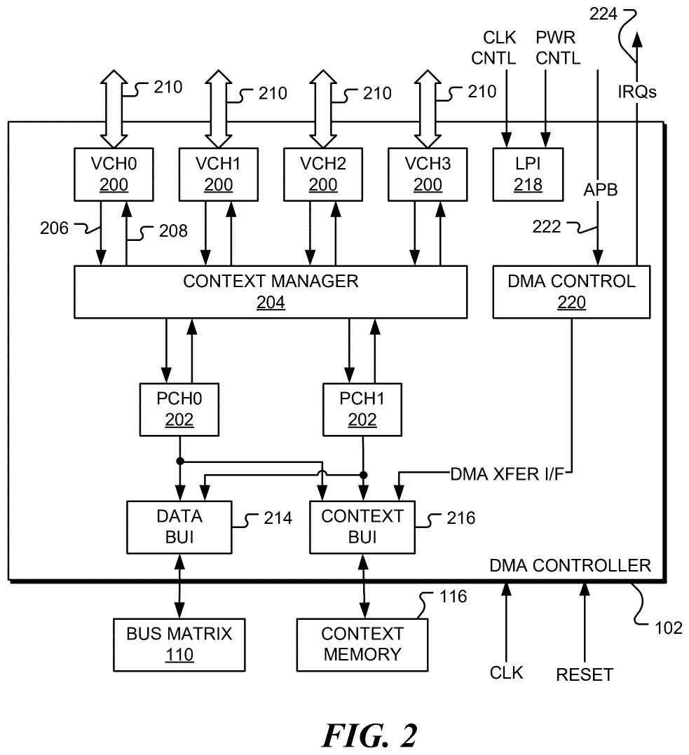

FIG. 2 is a block diagram of a direct memory access controller (DMAC) 102 in accordance with various representative embodiments. DMAC 102 provides fast memory to memory, peripheral to memory, memory to peripheral copy, and peripheral to peripheral capabilities on multiple channels and may have configurations for different types of copy, scatter-gather, and increment transfers.

DMAC structurally divides DMA channels into virtual channels (VCH) 200 and one or more physical channels (PCH) 202. Virtual channels implement the aspects that are unique to each DMA channel (such as triggering and flow control) while physical channels consist of logic circuitry and other resources that are identical for each DMA channel. In the embodiment shown in FIG. 2, DMAC 102 implements two physical channels (PCH0 and PCH1) that are shared between four virtual channels (VCH0, VCH1, VCH2 and VCH3). In general, the multiple virtual channels share fewer physical channels. In one embodiment, the DMAC has 2-32 physical channels, and the number of virtual channels is a multiple (e.g., two, four or eight times) of the number of physical channels.

Sharing of physical channels is controlled by context manager 204. In one embodiment, a virtual channel requests access to a physical channel on request line 206. When a request is granted, context manager signals the virtual channel on grant line 208. Context manager 204 controls the allocation and de-allocation of virtual channels to physical channels.

Virtual channel 200 may include an interface to trigger lines 210 and provide the related control logic for receiving peripheral trigger signals and transmitting triggers and other general-purpose output (GPO) for command and flow control between the DMAC and the peripheral devices. The trigger interfaces can be used to control the interaction of the DMA channel operation with other peripherals. An external peripheral or device can control the execution of DMA commands through the trigger input interface. The DMAC can also control external peripherals through its trigger output interface. The trigger input and trigger output interfaces are compatible with each other. Because of this compatibility, it is also possible to connect two DMA channels together inside the DMAC or by chaining multiple DMA controllers together. In addition to the hardware trigger interfaces, software trigger interfaces may be provided through channel control registers, programmable by an external device to produce a trigger input that enables an external device executing software to interact with triggering and flow control.

It is noted that virtual channels 200 are not abstract entities. Rather, they are implemented in hardware in DMAC 102. The hardware is configured to generate memory and peripheral addresses to be sent to a physical channel. A virtual channel cannot cause a DMA transfer without being allocated to a physical channel. A virtual channel may include context finite state machine (FSM) logic that tracks its own allocation status and handles the interactions with the context manager.

Physical channels (PCH) 202 implement read and write control logic to generate read and write data transfer requests. Each physical channel is allocated to one virtual channel at a time.

Commands are sent to data bus interface unit (BIU) 214 that arbitrates between DMA data transfer requests or command descriptor read requests during command linking. Selected requests are placed on the AHB bus and sent to bus matrix 110 for routing. Context BIU 216 is used for accessing context memory 116.

In one embodiment, DMAC 102 includes low power interface (LPI) module 218 that provides support for both clock and power control via a clock control channel (CLK CNTL) and a power control channel (PWR CNTL).

DMA control logic block 220 controls global operation of the DMAC. It may also handle channel related security filtering and other restrictions. The control block may have its own register bank that can be accessed by privileged software via a separate address range. DMA control logic block 220 may include an APB interface to APB bus 222 and may use interrupt request channel 224 to signal channel and/or global GMAC events. DMA control logic block 220 may be coupled, via context BIU 216, to context memory 116, whereby DMA control logic block context, such as configuration registers values, may be stored and retrieved.

In one embodiment, virtual channel context data is stored in a memory outside of the DMAC module. The context memory may be a fixed, private area in the system memory. Performance of the DMAC is increased if its DMA accesses and context memory accesses do not compete with each other for the same AHB interface. For this reason, the DMAC may have separate AHB interfaces: a data interface 214 dedicated to DMA transfers, and a context interface 216 dedicated to context memory accesses.

DMAC 102 may include additional inputs, such as a clock (CLK) input and a reset (RESET) input, in addition to other inputs and outputs not shown in FIG. 2.

Configuration data and status information may be stored in the DMAC's software (SW) visible registers. These registers allow software entities with adequate security and privilege levels to configure the DMAC's behavior and read status on DMA unit-level, DMA channel-level and DMA command-level.

Configuration data from command descriptors may be provided from an external source. The command descriptors are used for configuring DMA commands without direct software interaction when command linking is enabled. The command descriptors may be stored in the system memory within a linked list data structure. Each command has information on what DMA channel configuration registers must be updated and a pointer to the next command.

Channel context data includes DMAC-specific microarchitectural information for each virtual channel. Channel context data is stored externally until the virtual channel gets allocated to a physical channel and the context data is loaded into the physical channel registers.

Hardware (HW) trigger input control information, provided via trigger input ports, enables a peripheral to start the operation of the DMA channel or for a flow control mechanism to be implemented while carrying out commands. For example, HW trigger output control information Trigger output ports can signal the end of a DMA command to another peripheral, implementing a handshake mechanism for synchronization purposes.

Miscellaneous HW configuration and additional control information may be provided via top-level ports and interfaces. HW control information may include, for example, boot control signals, a default context base address, a cross-trigger interface (CTI) and Secure/Non-secure all-channel stop and pause handshake interfaces.

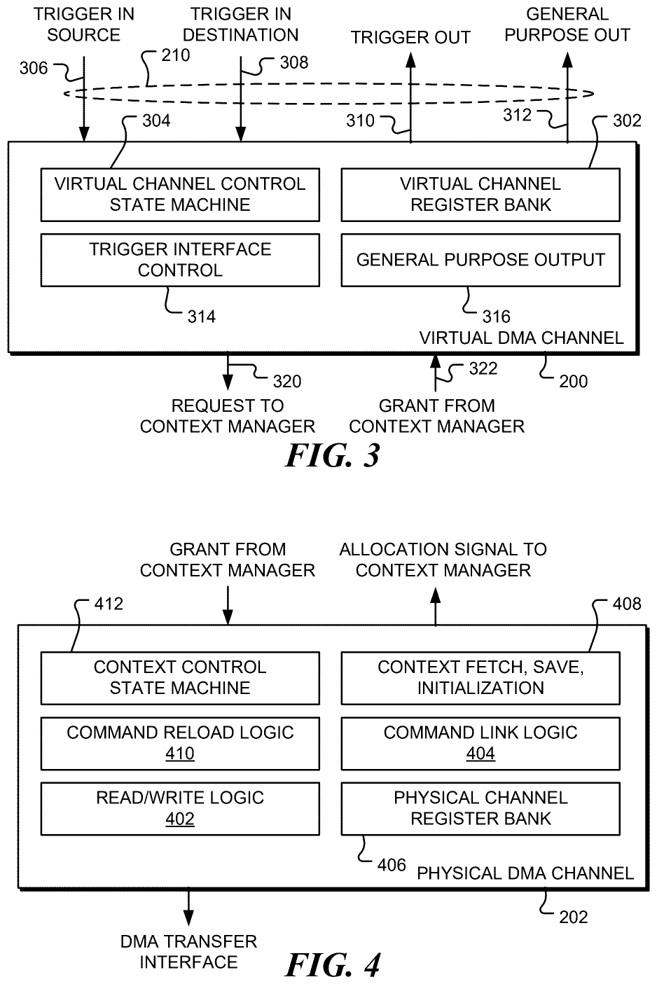

FIG. 3 is a block diagram of a virtual channel 200 of a DMAC, in accordance with various representative embodiments. The virtual channel is implemented in hardware. Virtual channels (VCH) implement the aspects of a DMA transfer that are unique to each DMA channel, while physical channels consist of logic and resources that are identical for each DMA channel. Software executed on a processor is used to configure channels via values stored in local virtual channel register bank 302. Virtual channel 200 includes virtual channel control Finite-State Machine (FSM) 304 that tracks and coordinates the lifecycle of the DMA command the channel is executing. For example, during the lifecycle of a command, channel control FSM 304 executes ENABLE, DISABLE, PAUSE, RESUME and STOP commands, validates command configuration, waits for trigger inputs, waits for allocation, handles being in preemptive paused state and performs automatic command restart and command link fetch.

Trigger inputs 210 may include DMA source trigger 306, DMA destination trigger 308. Outputs may include output trigger 310 and general-purpose output 312. Trigger control block 314 provides an interface and the related control logic for trigger support. DMA channels can have peripheral trigger ports for autonomous command and flow control between the DMAC and the peripherals. Each virtual channel has its own trigger control block 314, which handles the corresponding external trigger interfaces. A virtual channel may generate a flow control signal for controlling flow of the DMA channel. The flow control signal may be based on one or more trigger inputs.

Trigger input ports enable peripherals to communicate with the DMAC and sequence DMAC operations without SW intervention. Triggers provide flow control for transfers within a DMAC operation and can also be used to start entire DMAC operations. The mode in which the trigger input is used can be selected via configurable registers.

In one embodiment, virtual channel 200 includes a general-purpose output (GPO) interface 316. The GPO may be used, for example, for selecting memory banks, indicating a channel operation on a debug pin, controlling external hardware entities, and more. GPOs may be driven per channel, so each virtual channel has its own port or ports.

A virtual channel cannot perform DMA transfers without being allocated to a physical channel PCH. Each virtual channel tracks its own allocation status via signals from the PCH forwarded by the context manager. The context manager controls the virtual channel allocation/de-allocation to physical channels. Virtual channel 200 generates requests 320 to the context manager and receives notifications 322 when an allocation is granted.

VCHs represents the unique, non-shareable parts of a regular DMA channel. Each VCH has its own channel control and pause FSMs that track and coordinate the DMA command's lifecycle the channel is executing. Also, VCHs may have their own channel registers implemented locally. Furthermore, VCHs have their own trigger interfaces and the related control logic when trigger support is configured. Similarly, each VCH has their own GPO interface when GPO support is configured.

FIG. 4 is a block diagram of a physical channel 202 of a DMAC, in accordance with various representative embodiments. Physical channel 202 implements read and write control logic 402 for data transfers, including burst calculation logic and pipelines. Each physical channel is allocated to one virtual channel at a time. Physical channels also implement command linking logic 404 for reading command descriptors and based on those performing the necessary updates to the relevant registers in local physical channel register bank 406 and in the virtual channel and the context memory. Each physical channel implements its own context fetch/save logic 408, as well as the register reload logic 410, which is used by commands for which automatic reload is set.

Command descriptors are a set of values that describe a data transfer. These values are loaded into physical channel register bank 406. For example, the command descriptors may include a source address SRCADDR, a destination address DESADDR, a transfer size TRANSIZE (the number of elements to transfer), an element size XSIZE, and source address increment value SRCADDRINC, and a destination address increment value DESADDRINC.

A DMA command may transfer one or more data values from one or more source addresses in an external source device to one or more destination addresses in an external destination device. The external source device may be a peripheral device or a memory device, for example. The external destination device may be a peripheral device or a memory device, for example.

Register reload logic 410 updates the command descriptor when a command is completed or repeated. If the physical channel is de-allocated before the whole transfer is completed, the “pending” command descriptor is saved to the context memory. The “pending” command is fetched from the context memory when the virtual channel is next granted access to a physical channel, whether it be the same physical channel or a different physical channel.

Physical channel (PCH) 202 includes context control FSM logic 412, which handles interactions with the context manager, including receiving grants 414 and sending allocation signals 416.

Physical channel 202 is connected to bus interface units (BIUs) via DMA transfer interface 418. The BIUs serve as arbiters between physical channels that operate in parallel and generate transfers on their AHB interface as requested by the physical channels.

TABLE 1 shows example DMA command parameters. These parameters are stored in channel registers and form a portion of the context information. Channel registers may be stored either in a VCH or in a PCH. Some channel registers may be split, with some fields of the register stored in VCH while others are stored in PCH. Other parameters sets may be used without departing from the present disclosure.

TABLE 1

| PARAMETER | Description |
|---|---|
| CTRL | Control parameters |
| SRCADDR | Source address |
| DESADDR | Destination address |
| XSIZE | Transfer size |
| SRCTRANSCFG | Source transfer configuration |
| DESTRANSCFG | Destination transfer configuration |
| XADDRINC | Transfer address increment |
| SRCTRIGINCFG (BLKSIZE) | Source trigger input configuration |
| DESTRIGINCFG (BLKSIZE) | Destination trigger input |
| | configuration |
| LINKADDR (all but | Address offset to next command + |
| LINKADDREN) | enable bit |
| LINKATTR | Link attributes |
| AUTOCFG (CMDRESTARTCNT) | Automatic restart |
| NSEC_CHCFG/SEC_CHCFG | Secure/non-secure configuration |
| (CHID) | |

In one embodiment, a command linking feature is used to enable the DMA channels to execute more operations by automatically loading the next commands from the system memory to its configuration registers. This feature makes the DMAC versatile in combining multiple commands in a DMAC transaction. Each linked command can define new transfer parameters, triggering behavior, and interrupt settings. This provides great flexibility in the possible usage of the DMA unit and makes it possible to implement complex data transfer tasks by carefully designing command chains. The commands are defined by command descriptors stored in memory. The channel fetches the command descriptors by using the pointer address stored in a link register (“LINKADDR” in TABLE 2 below). The first command is set directly in the channel registers to start the linked command chain. If required, the first command can be an empty command which only points to a memory location with the first non-empty command. Certain commands might only change some of the configuration registers, for example, the destination address or the number of transfers, but keep all other registers the same for the next command. To do this, the command descriptors in the memory have a header part that specifies what registers to update in the channel register bank. This reduces the number of bus transfers executed during command fetching. The command link chain finishes when a command in the chain does not have a specified bit set. For example, the least significant bit of the link address may be used to indicate if an additional command is linked or not. The new command is fetched when a command is finished. The register values are read and updated according to the header word. Execution of a command chain can be stopped by setting a bit in a channel command register, for example. The command being executed currently is finished but the next one is not loaded.

When a command in the command link stopped, the remaining part of the command and the remaining part of the command link are canceled. The stop waits for all the outstanding responses from read and write transactions, but it tries to finish the channel operation as soon as possible.

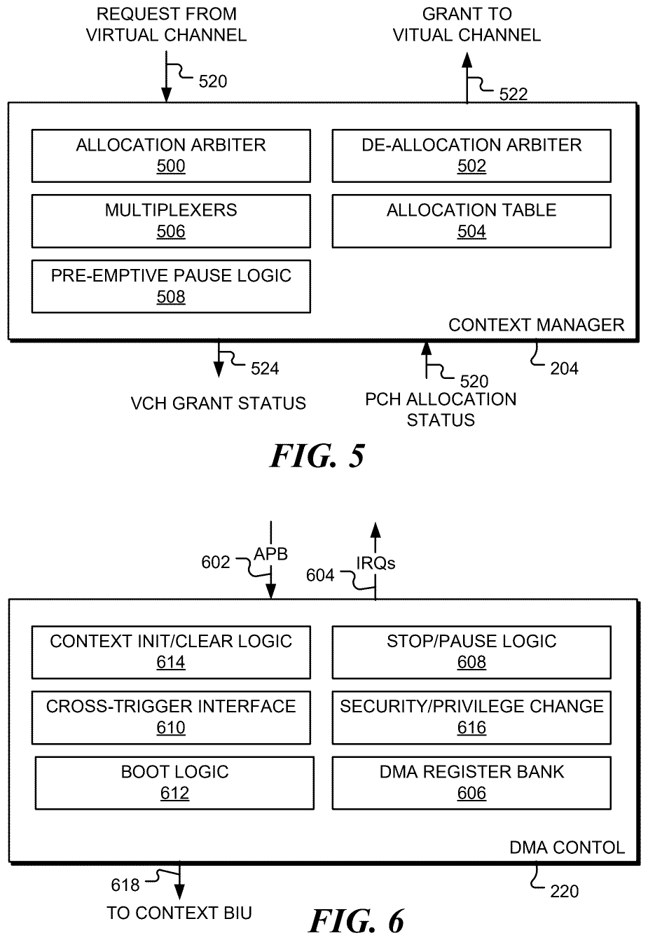

FIG. 5 is a block diagram of a context manager 204 of a DMAC, in accordance with various representative embodiments. Context manager 204 provides an arbitration layer between the virtual channels and the physical channels. It determines which virtual channel (VCH) gets allocated to which physical channel (PCH), and if necessary, which virtual channel gets de-allocated. By granting or revoking access, the context manager triggers the relevant processes in the involved VCH and PCH which will result in their allocation or de-allocation, respectively. The multiplexing of any signaling between the VCH and PCH is also handled by the context manager. Context manager 204 includes allocation arbitration logic 500 and de-allocation arbitration logic 502 that together update allocation table 504. Routing control logic 506, such as multiplexers, connects virtual channels to their allocated physical channels.

Context manager 204 also includes pre-emptive pause logic 508. Preemptive pause prevents priority inversion in the DMA and is discussed in more detail below.

Context manager 204 receives requests 520 from virtual channels and responds with grants 522 when a physical channel is allocated to service the request. Context manager 204 provides VCH arbitration grant status 524 to the physical channel and receives allocation status 526 from the physical channel.

Context manager 204 may provide allocation arbitration between virtual channels based on their priority. The highest priority level virtual channel wins the arbitration. If two or more virtual channels have the same priority, arbitration between virtual channels is done based on the least recently granted scheme. Based on the least recently granted scheme the oldest selected virtual channel wins the arbitration.

FIG. 6 is a block diagram of a DMA control logic block 220, in accordance with various representative embodiments. DMA control logic block 220 receives configuration and control commands from one or more processors (via bus APB 602) and may provide interrupt request signals to the processors on IRQs lines 604. DMA control logic block 220 provides a configuration interface that enables the behavior of the DMAC to be configured by tie-off signal or by values written into in register bank 606 when the DMAC is released from reset.

STOP/PAUSE logic 608 provides support response start and pause commands. For example, a command can be used to stop the operation of all the active channels of the DMAC. The stop function can be useful when dealing with error scenarios in the system and immediate action must clear the DMAC tasks. The stop waits for all the outstanding responses from read and write transactions and it tries to finish the channel operation as soon as possible by not sending more requests out and not asserting triggers. The operation of the DMA channels can be paused immediately at a point in time by a command to pause all channels from an external hardware unit. The pause function can be useful to freeze the channels in a state and check the current values of its registers, or to pause the DMA unit for a while to free up bus infrastructure resources. Channels may remain enabled. Transfer and trigger states may be retained so that no information is lost. When the pause request is de-asserted, the operation continues.

The DMA control logic block may provide a cross-trigger interface (CTI) 610 that allows pausing and resuming all channels at once. The CTI is required in a system where a processor is halted for debug purposes and the debugger must save the actual memory contents so the DMAC can also be paused to avoid corrupting the current state of the system.

Boot logic 612 provides automatic booting of the DMAC and may be controlled by a “boot-enable” input, for example.

In one embodiment, certain registers in the APB register space are protected for higher privilege and security software modules. These registers configure the overall behavior of the DMAC and are protected internally within the DMAC.

Context INIT/CLEAR block 614 implements a “register clear” mechanism that clears all channel registers related to the execution of the DMA command (such as those listed in TABLE 1 above), and when present, the CHID (channel identifier) register. If a VCH is de-allocated when the register clear mechanism is performed on the channel's registers, the DMAC clears the corresponding area in the context memory by generating write transfers on the context bus.

Block 616 monitors change in security and privilege settings of the virtual channels. Both events trigger a register clear sequence to prevent data leakage.

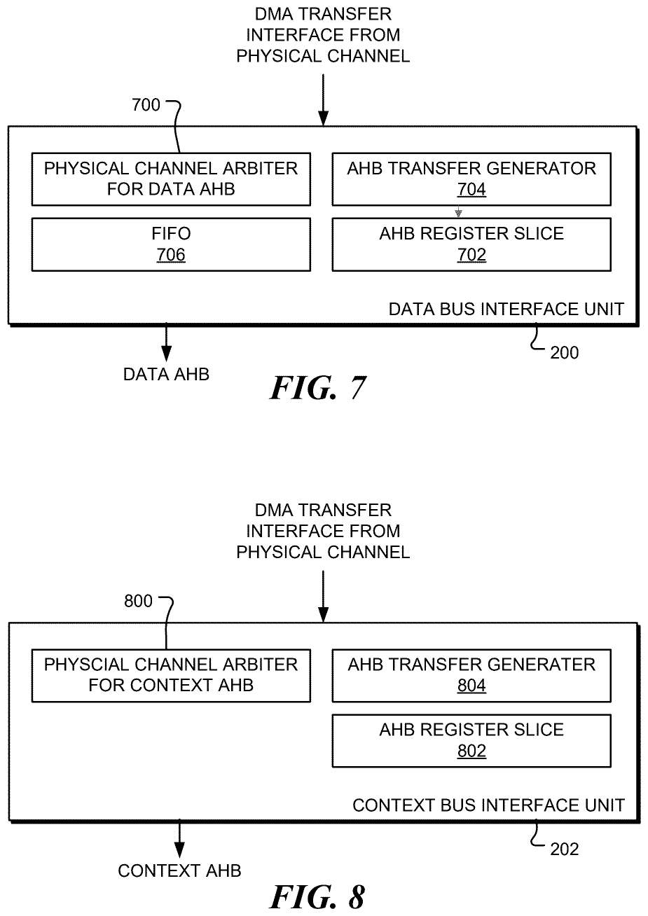

FIG. 7 is a block diagram of a data bus interface (BIU) 214 of a DMAC, in accordance with various representative embodiments. Data BIU 214 includes physical channel arbitration logic 700 for the AHB. This arbitrates between bus access requests from multiple physical channels (e.g., PCH0 and PCH1 in FIG. 2). AHB register slice 702 is a pipelined buffer that provides timing isolation of bus signals and enables matching of signal delay and latency. Transfer generation block 704 generates bus data corresponding to requests received from a physical channel.

FIG. 8 is a block diagram of a context bus interface (BIU) 216 of a DMAC, in accordance with various representative embodiments. Context BIU 216 includes physical channel arbitration logic 800 for the AHB, which arbitrates between bus access requests from multiple physical channels (e.g., PCH0 and PCH1 in FIG. 2). AHB register slice 802 provides timing isolation of bus signals to enable matching of delay and latency. Transfer generation block 804 generates bus data corresponding to requests received from a physical channel.

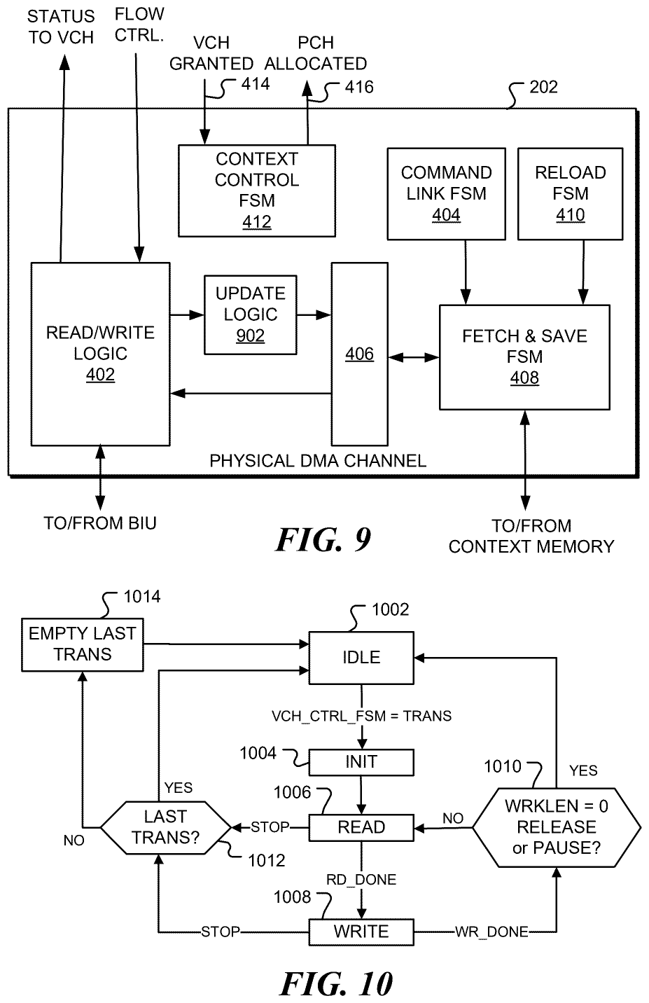

FIG. 9 is a further block diagram of a physical channel 202 of a DMAC, in accordance with various representative embodiments. Physical channel 202 implements read and write control logic 402 for data transfers, including burst calculation logic and pipelines. Read and write control logic 402 may include a read and write finite state machine (FSM). Each physical channel is allocated to one virtual channel at a time. Physical channels also implement command linking logic 404, which may be a finite state machine (FSM) for reading command descriptors and based on those performing the necessary updates to the relevant registers in local physical channel register bank 406 and in the virtual channel and the context memory. Each physical channel implements its own context fetch/save logic 408, as well as the register reload logic 410, which is used by commands for which automatic reload is set. The logic may include finite state machines, as described below.

Command descriptors are a set of values that describe a data transfer. These values are loaded into physical channel register bank 406 from a system memory, for example. In one embodiment, the command descriptors include a source address SRCADDR, a destination address DESADDR, a transfer size TRANSIZE (the number of elements to transfer), an element size XSIZE, and source address increment value SRCADDRINC, and a destination address increment value DESADDRINC.

These registers may be wide registers (e.g., 32 bits). Since there are fewer physical channels than virtual channels, placing the registers in the physical channels reduces the footprint of the DMAC circuit.

Update logic 902 updates the command descriptor when a read/write for an element is completed. In one embodiment, the command descriptor is updated.

$$\begin{matrix}SRCADDR ← SRCADDR + SRCADDRINC * XSIZE \\ DESADDR ← DESADDR + DESADDRINC * XSIZE \\ TRANSIZE ← TRANSIZE - 1\end{matrix}$$

The values of XSIZE, SRCADDRINC and DESADDRINC are unchanged. The updated command descriptor indicates the part of the total transfer still pending. If the physical channel is de-allocated before the whole transfer is completed, the “pending” command descriptor is saved to the context memory. The “pending” command is fetched from the context memory when the virtual channel is next granted access to a physical channel, whether it be the same physical channel or a different physical channel.

Physical channel (PCH) 202 includes context control FSM logic 412, which handles interactions with the context manager, including receiving grants 414 and sending allocation signals 416.

FIG. 10 is a diagrammatic representation of a read and write finite state machine (FSM), in accordance with various representative embodiments. This module generates the data read and write bursts to be requested from the BIU. The FSM waits in an initial IDLE state 1002 until a virtual channel control FSM (VCH CTRL FSM) reaches a data transfer state, at which time it transitions to INIT state 1004. In the INIT state, internal registers are loaded for calculating work lengths and burst sizes. The FSM changes to the READ state 1006 with next clock. In READ state 1005, read bursts are generated as long as there is available space in the FIFO of the BIU or until a “stop”, “pause” or “transfer release” request is received. When the read is done (FIFO is full) the FSM transitions to WRITE state 1008, where write bursts are generated as long as there is data in FIFO of the BIU or a “stop” request is received. When the write is done, the FSM transitions to IDLE state 1002 if the remaining work length (WRKLEN) is zero, or a “pause” or “release” request is received, as depicted by the positive branch from decision block 1010. Otherwise, when WRKLEN>0, the FSM returns to READ state 1006.

A “stop” request may be received while in the READ or WRITE state, The current transfer is already the last transfer, as indicated by the positive branch from decision block 1012, the FSM transitions to IDLE state 1002. Otherwise, as depicted by the negative branch from decision block 1012, the FSM transitions to EMPTY_LAST_TRANS state 1014, where the last transfer is emptied. The FSM then transitions to IDLE state 1002.

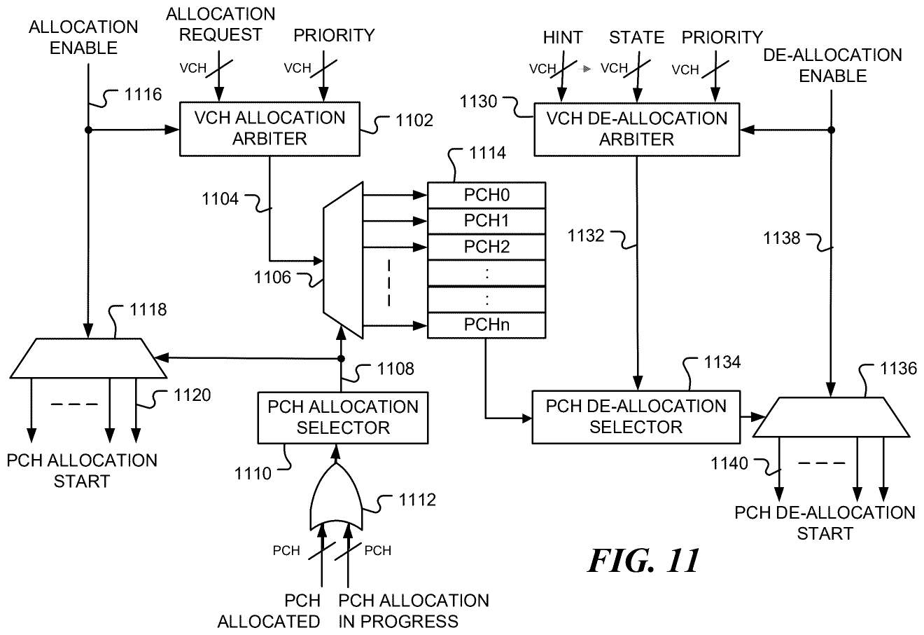

FIG. 11 is a block diagram of a context manager, in accordance with various representative embodiments. FIG. 11 shows allocation and de-allocation logic. The function of the context manager is to control the allocation and de-allocation processes, track the current allocation status of virtual and physical channels, intervene if there is a priority inversion scenario and create the connections between virtual and physical channels allocated to each other. When virtual channels reach the point in their operation when they need the functionality of a physical channel to be able to progress, they request allocation by providing an ALLOCATION REQUEST signal to VCH allocation arbiter 1102. The context manager is responsible for arbitrating between multiple allocation requests coming from the virtual channels. Allocation arbitration between virtual channels is done based on their priority. The priority values of each virtual channel are indicated by the PRIORITY signal provided to VCH allocation arbiter 1102.

Signal 1104 indicates the virtual channel currently selected for allocation and is fed to multiplexer 1106.

Signal 1108, generated by PCH allocation selector 1110, indicates the allocated physical channel. This signal is calculated using the PCH ALLOCATED and PCH ALLOCATION IN PROGRESS signals, which are combined in logical OR unit 1112. Signal 1108 controls multiplexer 1106 and determines which entry of allocation table 1114 will store the identifier of the selected VCH. Each entry of allocation table 114 is associated with a physical channel and stores an identifier of the virtual channel to which the physical channel is allocated.

ALLOCATION ENABLE signal 1116 may be asserted when there is at least one virtual channel that is requesting for allocation and either there is a physical channel that is de-allocated or the requesting virtual channel that is currently selected by the allocation arbiter still has its physical channel context saving. PCH selection signal 1108 control multiplexer 1118 to send a PCH ALLOCATION START signal 1120 to the selected physical channel. Multiplexer 1118 is part of the routing control logic.

When virtual channels reach the point in their operation when they do not need the functionality of a physical channel anymore (even temporarily), they hint for de-allocation using a HINT signal to VCH de-allocation arbiter 1130. A virtual channel may hint that it can be de-allocated from a physical channel when the virtual channel is in one of the following states:
Disabled state
Command trigger state if trigger request is LOW
Flow control trigger state if trigger request is LOW
Trigger out state if trigger acknowledge is LOW
Paused or Preemptive paused state

The context manager is responsible for arbitrating between multiple de-allocation hints coming from the virtual channels. De-allocation hints can only come from ALLOCATED virtual channels. VCH de-allocation arbiter 1130 selects the VCH for allocation, indicated in signal 1132, based on the hints, and also on the state of the VCH (indicated by signal STATE) and the priority of the VCH (indicated by priority signals PRIORITY).

PCH de-allocation selector 1134 selects the physical channel to be de-allocated based on the selected VCH 1132 and the contents of allocation table 1114. The selected physical channel is used to control multiplexer 1136 to route de-allocation enable signal 1138 to the selected physical channel as a PCH de-allocation start signal 1140. De-allocation enable signal 1138 indicates a de-allocation arbitration point when there is at least one virtual channel that is requesting for allocation, there is at least one virtual channel that can be de-allocated (i.e., hinting for de-allocation), and all physical channels are ALLOCATED.

Thus, the context manager receives allocation requests and de-allocation hints from the VCHs and generates allocation and de-allocation start signal for the PCHs.

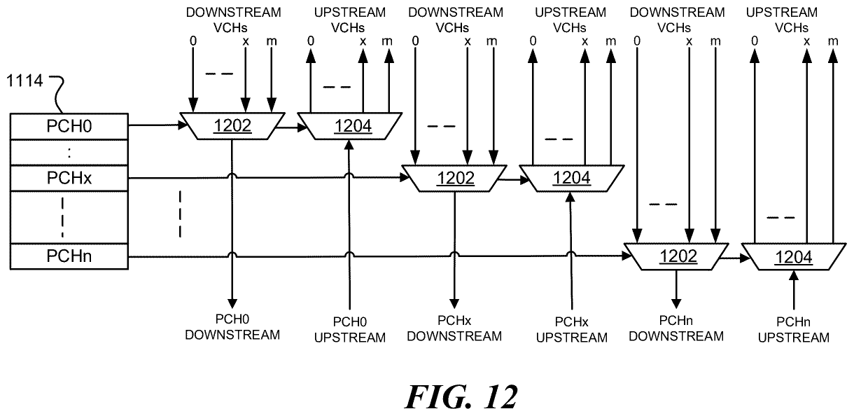

FIG. 12 is a further block diagram of a context manager, in accordance with various representative embodiments. As described above with reference to FIG. 11, each entry in allocation table 1114 is associated with a physical channel and contains an identifier of a virtual channel allocated to the that physical channel. The entries are used to control downstream signal multiplexers 1202 and upstream signal multiplexers 1204 for routing signals between the virtual channels and the allocated physical channels. Multiplexers 1202 and 1204 are part of the routing control logic of the context manager. The signals may include status signals for example. There is one upstream and one downstream multiplexer for each of the n+1 physical channels (PCH0-PCHn), and each multiplexer switches between m+1 virtual channels (VCH0-VCHm).

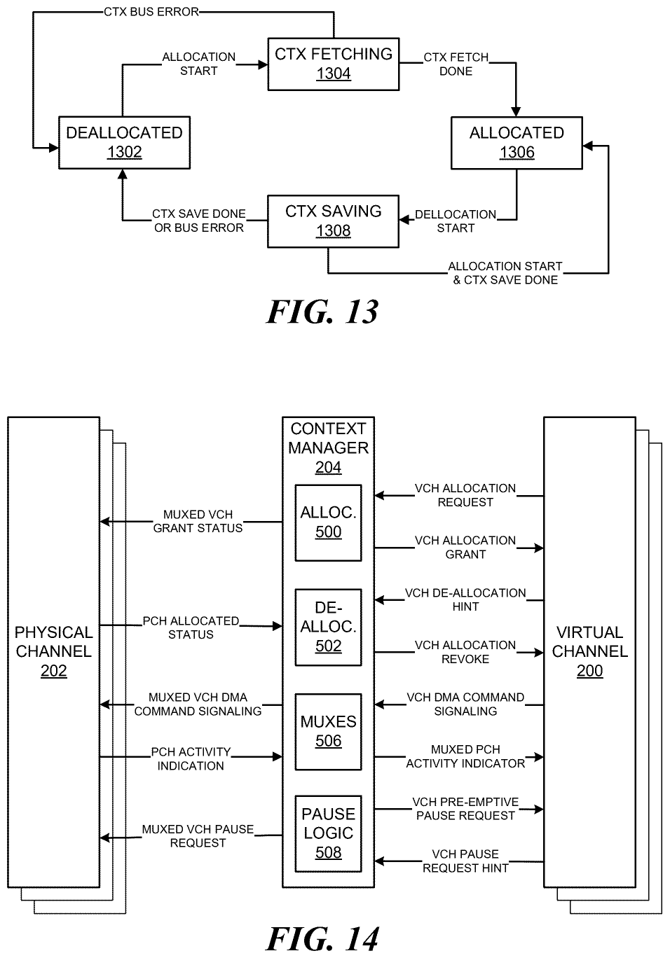

FIG. 13 is a diagrammatic representation of a context FSM for a physical channel, in accordance with various representative embodiments. At start-up, physical channels be in DE-ALLOCATED state 1302. A rising edge on the ALLOCATION START signal (1120 in FIG. 11) indicates the start of an allocation process. This will transition the FSM to CTX FETCHING state 1304, which indicates context fetching. When context fetching is done, the FSM transitions to ALLOCATED state 1306.

A rising edge on the DE-ALLOCATION START signal (1140 in FIG. 11) indicates that the associated VCH is revoked and the internal PCH register values must be saved to CTXMEM. This causes the FSM to transition to CTX SAVING state 1308. When context saving is done, the FSM transitions back to DE-ALLOCATED state 1302.

Should a bus error occur while fetching or saving the context, the FSM transitions back to DE-ALLOCATED state 1302.

FIG. 14 is a block diagram showing signal flow in accordance with various representative embodiments. Signals flow between a virtual channel 200 and a physical channel 202 via context manager 204. Context manager 204 provides the arbitration layer between the virtual channels 200 and physical channels 202. It decides which virtual channel gets allocated to which physical channel, and if necessary, which virtual channel gets de-allocated. By granting or revoking access, the context manager triggers the relevant processes in the involved VCH and PCH which will result in their allocation or deallocation, respectively. The multiplexing of any signaling between the VCH and PCH is also handled by the context manager.

Virtual channels make requests for allocation in the context manager with signal VCH ALLOCATION REQUEST. The context manager arbitrates between these requests and a virtual channel is granted, as signaled by signal VCH ALLOCATION GRANTED, when the allocation arbiter 500 selects that virtual channel for allocation and the conditions of an allocation arbitration point are satisfied. A physical channel 202 is connected to a virtual channel 200 when an allocation grant, indicated in signal MUXED VCH GRANT STATUS is issued by the context manager. A downstream multiplexer of multiplexers 506 selects the allocated PCH. At this point, the physical channel starts the context fetching and when it is done with the process it signals for the virtual channel that it has been allocated. From that point, both the physical channel and the virtual channel is in allocated state.

An allocation sequence starts with an allocation grant for any of the requesting virtual channels. It contains the full process of context fetching which is controlled by the virtual channel and the physical channel and lasts until the physical channel signals that it has been allocated. Virtual channels hint to de-allocation arbiter 502 of the context manager for de-allocation using the signal VCH DEALLOCATION HINT. The context manager arbitrates between these hints and a virtual channel is revoked, as indicated by signal VCH ALLOCATION REVOKE, when the de-allocation arbitration selects that virtual channel for de-allocation and the conditions of a de-allocation arbitration point are satisfied. The corresponding physical channel starts the context saving when the connected virtual channel is revoked. When it is done with the process it signals for the virtual channel that it has been de-allocated using the PCH ALLOCATION STATUS signal. The de-allocation sequence starts with an allocation revoke for any of the virtual channels that is signaling a deallocation hint. It contains the full process of context saving which is controlled by the virtual channel and the physical channel and lasts until the physical channel signals that it has been deallocated. The physical channels have a context FSM that controls the process of context switching.

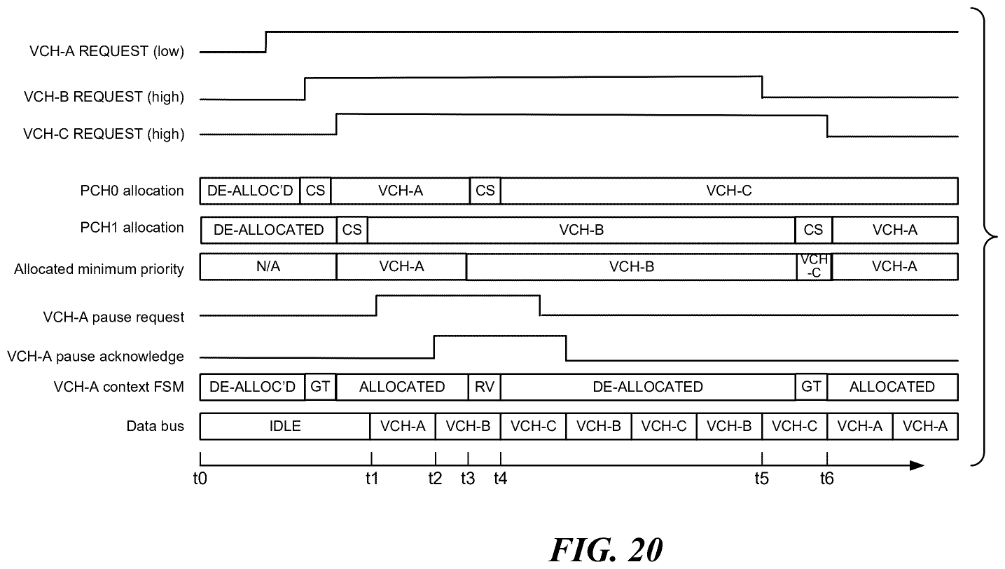

Preemptive pause logic 508 prevents priority inversion in the DMA, which is when a high priority virtual channel cannot access a physical channel due to a lower priority virtual channel being unable to progress its operation. As it cannot progress, it never reaches a point where it could give up its shared resources to the high priority virtual channel. A preemptive pause request in signal VCH PRE-EMPTIVE PAUSE REQUEST is issued by the context manager when it detects an incoming allocation request from a high priority channel that cannot be granted for the reason described above. The preemptive pause request is issued to the lowest priority allocated virtual channel, this virtual channel forwards the request to the physical channel allocated to it. A VCH may hint to the context manager that a pause is possible using VCH PAUSE REQUEST HINT signal. When a VCH is selected to be paused, the allocated PCH is signaled in signal MUXED VCH PAUSE REQUEST. An example of a priority inversion is described below with reference to FIG. 20. PCH ACTIVITY INDICATION signals are passed to the context manager and routed to the paired VCH in signal MUXED PCH ACTIVITY INDICATION.

VCH DMA COMMAND SIGNALING signals are passed to the context manager and routed to the allocated PCH in signal MUXED DMA COMMAND SIGNALING.

Additional signaling may be incorporated without departing from the present disclosure.

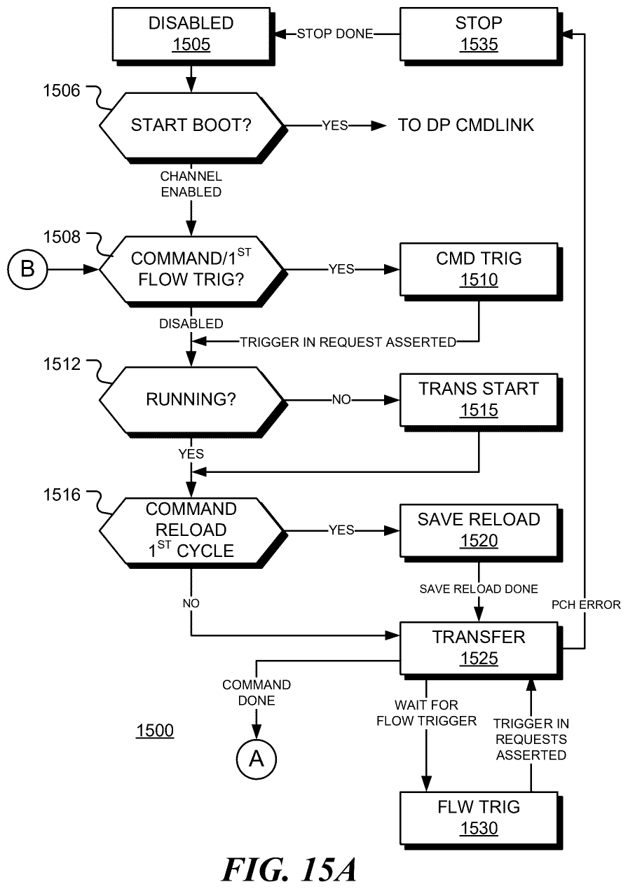

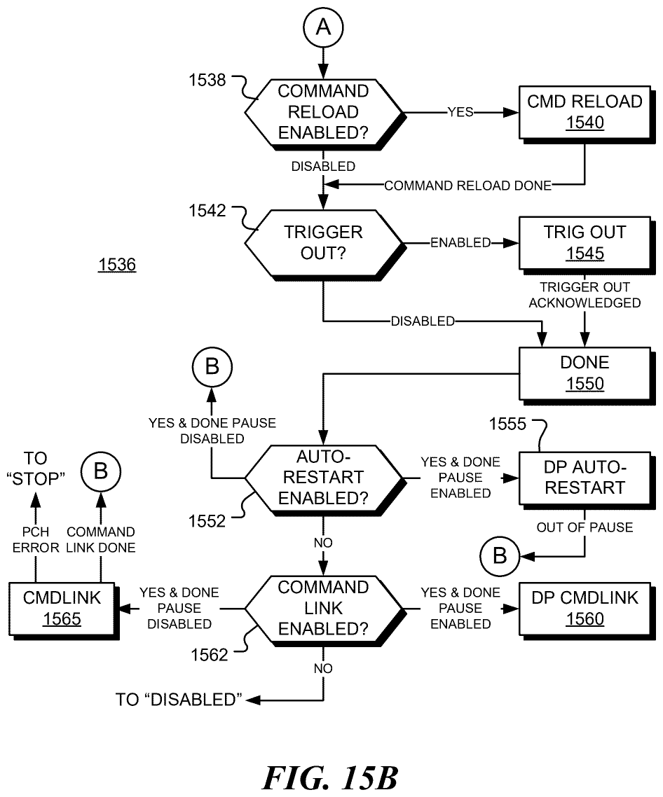

FIGS. 15A and 15B together constitute a flow chart of a virtual channel control FSM, in accordance with various representative embodiments. Referring to flow chart 1500 in FIG. 15A, the VCH control FSM begins in the default DISABLED state 1505, in which the channel is not active, no command execution is taking place. If the AUTOBOOT feature is enabled, as depicted by the positive branch from decision block 1506, the VCH transitions to DP_CMDLINK state to start fetching the boot command, there after going to CMDLINK. If command trigger and first flow control trigger requests are enabled, as depicted by the positive branch from decision block 1508, the channel transitions to CMD TRIG state 1510 when it is enabled. In CMD TRIG state 1510, the FSM waits for command trigger request, and the first flow control trigger request. General purpose outputs (GPOs) may be set based on an GPO configuration as soon as enabling occurs.

If triggers are not enabled or have arrived and the VCH is not ALLOCATED (i.e., not running) as depicted by the negative branch from decision block 1512, the FSM transitions to TRANS START state 1515 to wait for allocation. Once ALLOCATED it transitions to the next state.

Unless register reload is disabled in the configuration, the initial values of reloadable registers (source and destination address and size registers) must be saved to the context memory. As depicted by the positive branch from decision block 1518, the VCH control FSM transitions to SAVE RELOAD state 1520 and the physical channel starts the saving process. The next state is the TRANSFER state 1525, where data reads and writes are executed to transfer data from the source to the destination. The transfers are generated by the allocated physical channel once VCH control FSM is in TRANSFER state. If a PCH error occurs while in TRANSFER state 1525, the FSM transitions to STOP state 1535.

If flow control triggers are enabled the virtual channel will wait for trigger input requests in FLW TRIG state 1530.

After all transfers of the command have been transferred, flow continues to point “A” in flow chart 1536 in FIG. 15B.

Referring to flow chart 1536 in FIG. 15B, if reloading of commands into the register is enabled, as depicted by the positive branch from decision block 1538, the FSM transitions to CMD reload state 1540. While in this state, the initial values of registers are reloaded from the context memory. This is done by the physical channel which starts the loading process once the VCH control FSM is in CMD RELOAD state. The reloading is skipped if reload is disabled. If output trigger is enabled, as depicted by the positive branch from decision block 1542, the virtual channel will set its output trigger request and will wait for acknowledge in TRIG OUT state 1545. Once all data is transferred, all trigger handshakes are completed, and initial values are reloaded the virtual channel transitions to DONE state 1550.

If the DMAC is configured to auto-restart the command, then the FSM jumps back to point “B” (decision block 1508) in flow chart 1500 in FIG. 15B when the command is not configured to pause when done, or to DP_AUTO-RESTART state 1555 when configured to pause when done (where “DP” is a mnemonic for “Done Pause”). The previous command execution may restart with the same or updated size and address parameters. The restart counter is decremented while in DONE state 1550, if needed.

If auto-restart is not enabled for the command, as depicted by the negative branch from decision block 1552, but command linking is enabled, the FSM transitions to DP CMDLINK state 1560 when done-pause is enabled and to CMDLINK state 1560 when done-pause is not enabled. This starts the reading of the next command from memory. This is done by the physical channel, which starts the command link read process once the VCH control FSM is in CMDLINK state. When the reading of the new command is finished the virtual channel starts executing it by transitioning to point “B” in flow chart 1500.

Both auto-restart and command link can be stalled if the pause-when-done fields are set for pausing at the end of a cycle or at the end of a command. In this case the VCH control FSM waits for resuming in the DP_AUTO-RESTART state 1555 and the DP_CMDLINK state 1560.

If neither auto-restart nor command link is enabled, the VCH control FSM returns to DISABLED state.

If the virtual channel encounters an error condition from the physical channel or gets a stop request, it transitions to STOP state (1535 in flow chart 1500) where it waits for all interfaces and internal states to return to idle after which the VCH control FSM return to DISABLED state.

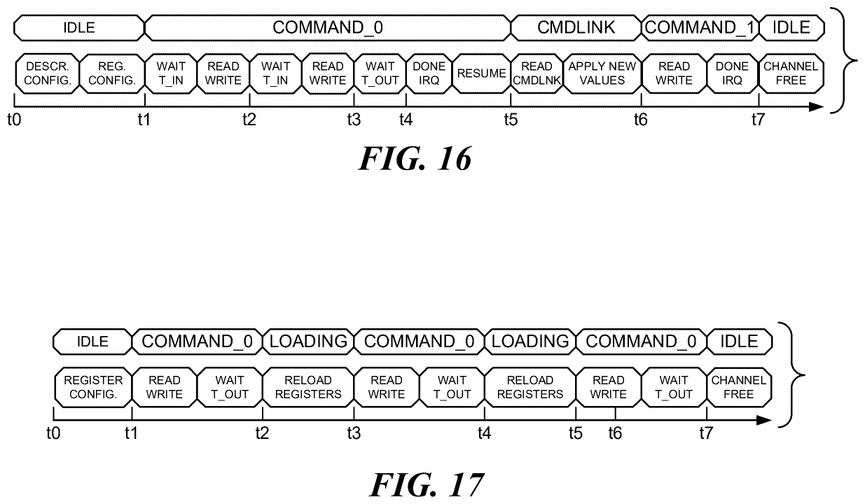

FIG. 16 is an example timing diagram for channel operation, in accordance with an embodiment. In this example, a “DONE” interrupt signal is generated when a command is complete and DONE PAUSE is enabled. The timing diagram shows how a linked command is configured and executed by a channel when the DONE interrupt is used with DONE PAUSE enabled to stall the operation until the external software resumes the execution. The following steps are described in more detail.

At time t0, the command descriptor in the memory is written and the DMA channel registers are configured. The last step of the configuration process is setting the ENABLE bit which starts the channel operation.

At time t1, the channel starts by waiting for a peripheral to trigger a block-based DMA request. When the trigger arrives, the DMA executes the preconfigured number of reads and writes for that trigger event.

At time t2, the channel waits for another trigger to execute the final read and write operations for this command. When received the data movement is executed as before.

At time t3, the channel asserts the trigger out and waits for an acknowledgement to arrive. The channel operation is halted until the acknowledgement is received.

At time t4, the acknowledge is received. This is the last step for this command. The configuration enables the DONE interrupt with DONE PAUSE setting for this command. This stalls further operation until the command is resumed by external software. This might be used for a synchronization point between the DMA and the software, to make sure all software activity is finished before the DMA starts executing the next command. When the interrupt is acknowledged the DMA starts reading the linked command.

At time t5, the DMAC reads the linked address. Based on the command header, the read new values are applied to the registers. When all the necessary registers are read, the next command starts executing.

At time t6, the next command is simply a few reads and writes and then the DONE interrupt is raised again. The channel remains enabled until any interrupt is pending. When the interrupt is cleared the operation is finished regardless of the DONE PAUSE enable settings, as this is the final command of the chain.

At time t7, the interrupt is acknowledged, and the channel returns to the IDLE state.

FIG. 17 is an example timing diagram for channel operation in accordance with an embodiment. This example shows the command execution when a single command is looped a couple of times and then disabled by software. The example uses the trigger out to provide control over the loop periodicity. This enables a command to be run in loops without any triggers or interrupts. The upper blocks indicate the state of the channel, while the lower blocks indicate the channel operations. The steps are described in more detail:

At time to, only the DMA channel registers need to be configured. For example, a “channel auto-configuration” register may be configured before the ENABLE bit which starts the channel operation in a looped fashion. The channel is in the IDLE state.

At time t1, the channel performs a few read and write operations and then waits for a trigger output to be acknowledged.

At time t2, the final write response is received, and the trigger is acknowledged. At this point, the channel reloads the starting values of the current command from its internal registers.

At time t3. the registers have their values set back to the beginning and the command can start again by doing the same read and write operations.

At time t4, the trigger acknowledgement is received again at the end of the command and the same values are reloaded again to start the next round of the loop.

At time t5, the same read and write operations are executed by the command.

At time t6, the software writes a designated “DISABLE” bit of the command to indicate that the looping shall be finished at the end of this command. The command still waits for a trigger acknowledgement at the end of the cycle.

At time t7, the register values are not reloaded at the end, so the channel returns to the IDLE state.

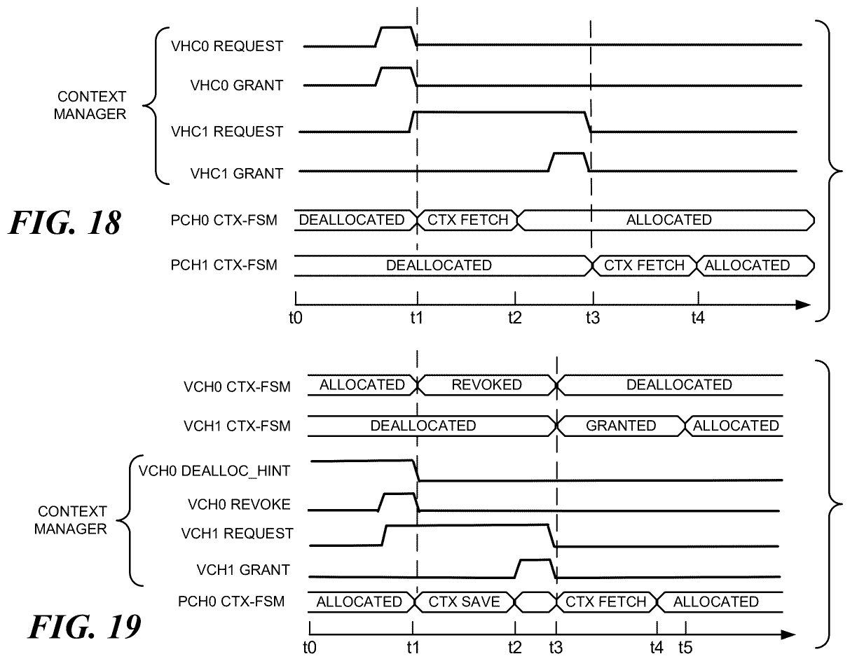

FIG. 18 is an example timing diagram, in accordance with various representative embodiments. This example illustrates a scenario in which two VCHs (VCH0 and VCH1) are de-allocated at time to and request allocation within a short time. The de-allocated VCH0 requests for allocation, as indicated by the VCH0 request signal. The request is granted instantly by context manager, as indicated by the VCH0 grant signal, since at least one PCH is free and there are no other ongoing allocation or de-allocation sequences. As PCH0 is the lowest-index free PCH, the context manager selects PCH0 as VCH0's allocation pair. As indicated by the PCH0 CTX-FSM, the state of PCH0 transitions from DEALLOCATED to CTX FETCH at time t1 and PCH0 starts context fetching. At the same time, the unallocated VCH1 requests for allocation, as indicated by the VCH1 request signal going high. Even though PCH1 is free, the context manager does not immediately grant the allocation because that would result in starting a second allocation sequence, since the allocation sequence for the VCH0-PCH0 pairing is not completed. PCH0 completes context fetching at time t2 and becomes fully allocated. At the same time, VCH1 receives the grant from the context manager, as indicated by signal VCH1 grant, and will be allocated to PCH1. Thus, at time t3, the PCH1 context FSM transitions from the DEALLOCATED state to the CTX FETCH state and PCH1 starts context fetching. PCH1 finishes context fetching at time t4 and becomes fully allocated. In this example, there is a delay from when VCH1 requests an allocation to when an allocation is granted.

FIG. 19 is an example timing diagram, in accordance with various representative embodiments. This example illustrates a simple context switching scenario.

At time to, VCH0 is allocated to PCH0, as indicated by the VCH0 CTX-FSM state in the figure. VCH0 is not actively performing transfers, instead it is asserting its de-allocation hint towards the context manager, indicating that it can be revoked if necessary. This is indicated by the VCH0 DEALLOC_HINT signal in the figure. VCH1 with the same or higher priority than VCH0 requests to be allocated. It instantly wins arbitration, and as a result the context manager immediately revokes VCH0 at time t1.

At time t1 VCH0 becomes revoked and PCH0 starts context saving, as indicated by the PCH0 CTX-FSM transitioning to the CTX SAVE state in the figure.

At time t2, PCH0 finishes context saving and becomes de-allocated, so the CTXMGR signals grant to VCH1, as indicated by the VCH1 grant signal.

At time t3, VCH0 becomes de-allocated, as indicated by the VCH0 CTX-FSM transitioning to the DEALLOCATED state. Also, at time t3, VCH1 becomes granted, and PCH0 starts VCH1 context fetching.

At time t4, PCH0 finishes context fetching and becomes allocated.

At time t5, VCH1 captures PCH0s allocation status and becomes allocated itself.

FIG. 20 is a timing diagram of a DMAC, in accordance with various representative embodiments. In the example shown in FIG. 20, there are three channels, channel A with low priority, and channels B and C with high priority. At time to, all channels are de-allocated. Channel A, associated with VCH-A, requests allocation first, as indicated by the VCH-A REQUEST signal. PCH-0 is selected for allocation to VCH-A and performs the associated context switch. At time t1, DMA channel A begins accessing the data bus. Channel A may be generating data bursts, for example. Channel B, associated with VCH-B, requests allocation next and PCH-1 is allocated to VCH-B. Channel B's transfers have a higher priority and get selected by the arbitrator of the data BIU. When channel C gets enabled, the external software expects it to take over channels A and B in a reasonable amount of time, since it has the highest priority. Channel A, with the lowest priority, should switch context with channel C but is unable to switch context until channel A's pending transfers complete. However, the transfers cannot be completed because the BIU is arbitrating channels B's transfers due to channel B having a higher priority. Thus, channel A is blocking channel C, and channel C is unable to progress because it is not getting allocated and cannot generate any transfers. The situation is resolved by the context manager signaling a pre-emptive pause request, at time t1, to VCH-A, which has the lowest priority. At this time, all PCH's are allocated, and the context manager has received an allocation request from a higher priority channel. At time t2, the first channel A transfer is complete, and VCH-A acknowledges the pause request, indicating that its allocation can be revoked. At time t3, the VCH-A context FSM enters a “revoked” state. PCH-0 is re-allocated to VCH-C and begins the associated context switch. At time t4, the re-allocation is complete. The BIU determines the channel C has the highest priority and begins channel C transfers on the data bus. At time t5, channel B transfers are complete and PCH-1 is re-allocated from VCH-B to VCH-A. When the channel C transfers are complete, at time t6, channel A transfers can finally progress on the data bus. In this manner, the highest priority channel has been able to complete its operation by displacing the lowest priority channel.

In summary, an embodiment of the disclosure provides a direct memory access controller (DMAC) that includes virtual channels, physical channels and a context manager. A virtual channel is configured to generate a flow control signal for execution of a direct memory access (DMA) command. A physical channel includes read and write control logic to initiate, responsive to the flow control signal, transfer of data from source device to a destination device in accordance with the DMA command. The context manager includes allocation logic configured to arbitrate between allocation requests from the virtual channels and allocate a physical channel to a selected virtual channel and routing logic configured to route a flow control signal from the selected virtual channel to the allocated physical channel.

A virtual channel may include one or more channel control registers, programmable by an external device to provide a trigger input, where the virtual channel is configured to generate the flow control signal in response to the trigger input.

A virtual channel may also include one or more trigger ports, configured to couple to the external source device or the external destination device, and a control finite state machine (FSM) configured to control a direct memory access (DMA) command in the virtual channel responsive to a signal on the one or more trigger ports. The control FSM may also generate the flow control signal based, at least in part, on a signal from a trigger port of the one or more trigger ports.

The context manager may also include de-allocation logic, in which case the control FSM of the virtual channel is configured to signal the context manager when the virtual channel is in a state where it can be de-allocated by the context manager. The context manager may also issue a pre-emptive pause request to a lowest priority virtual channel when a higher priority virtual channel cannot access a physical channel due to a lower priority virtual channel being unable to progress its operation. The lowest priority virtual channel forwards the pre-emptive pause request to the physical channel allocated to it.

In one embodiment, a physical channel includes a command descriptor store configured to store command parameters, corresponding command descriptor update logic configured to update one or more of the command parameters stored in the command descriptor store, and a context fetch and save finite state machine (FSM) to transfer command parameters between the command descriptor store and a context memory. The command parameters may include source and destination addresses, source and destination address increments, a data chunk size and a number of pending transfers, for example.

In one embodiment, the DMAC includes a DMA control logic block configured to clear all channel registers related to the execution of a DMA command when a virtual channel is de-allocated, and to generate write commands to clear an associated area in the context memory. The context memory may be coupled to the DMAC via a bus, with the DMAC also including a context bus interface unit coupled to one or more physical channels. The context bus interface unit may include bus arbitration logic to arbitrate between bus access requests from multiple physical channels, and transfer generation logic to generate bus requests corresponding to requests received from a physical channel.

In an embodiment, the DMAC includes a DMA control logic block with DMAC global control logic, a bus interface for exchanging configuration data with external hardware, an interface to virtual channel and physical channel configuration registers, and a bridge to the context bus interface unit to enable access to a context memory by the external hardware. The DMA control logic block may also include an interrupt controller configured to collect DMA channel status signals from the virtual channels and generate therefrom interrupt signals on associated channels on an interrupt bus.

In an embodiment, external source and destination devices are coupled to the DMAC via a data bus and the DMAC includes a data bus interface unit (BIU) coupled to one or more physical channels. The BIU includes bus arbitration logic to arbitrate between bus access requests from multiple physical channels, transfer generation logic to generate bus requests corresponding to requests received from a physical channel, and a buffer for storing data read from the external source device and to be written to the external destination device.

In an embodiment, routing logic of the context manager includes an allocation table maintained by the arbitration logic, each entry in the allocation table corresponding to a physical channel and indicating a virtual channel to which the physical channel is allocated. For each physical channel, a virtual-to-physical multiplexer selects a virtual channel, in accordance with an entry in the allocation table for the physical channel, and routes a signal from the selected virtual channel to the physical channel. For each physical channel, a physical-to-virtual multiplexer selects a virtual channel, in accordance with an entry in the allocation table for the physical channel, and routes a signal from the physical channel to the selected virtual channel.

Computer-readable code for fabrication of a direct memory access controller (DMAC), as described above, may be stored on a non-transitory computer-readable medium.

In one embodiment, a method of data transfer in a data processing system includes configuring, by external hardware, a command descriptor of a direct memory access controller (DMAC) for a DMA channel between an external source device and an external destination device. The DMAC includes circuitry for virtual channels, physical channels and a context manager. In response to allocation requests from one or more virtual channels, the context manager allocates a physical channel to a selected virtual channel and the selected virtual channel generates a flow control signal. The flow signal may be generated in response to one or more trigger inputs from the external source device, the external destination device, or both the external source device and the external destination device. In response to the flow control signal, the allocated physical channel initiates transfer of data from one or more source addresses in the external source device to one or more destination addresses in the external destination device, in accordance with the command descriptor. The context manager routes the flow control signal from the selected virtual channel to the allocated physical channel.

The command descriptor may include command parameters such as source and destination addresses, source and destination address increments, a data chunk size, and a number of data chunks to transfer between an external source device and an external destination device.

The DMAC may be configured to clear channel registers when a designated bit in a header of the command descriptor is set.

In an embodiment, allocating a physical channel to a virtual channel includes selecting a virtual channel, of the plurality of virtual channels requesting allocation, based, at least in part, on a priority value of the virtual channel, selecting a physical channel of the one or more physical channels that is neither allocated nor in a process of being allocated, and storing an identifier of the selected virtual channel in an entry of an allocation table corresponding to the selected physical channel.

Routing by the context manager may include controlling multiplexers of the DMAC in accordance with the entries of the allocation table.

In response to a change in allocation of a physical channel, an embodiment of the method includes saving a current context of the physical channel to a context memory and fetching a new context for the physical channel from the context memory. The saving or fetching of a context may include accessing an external context memory via a bus.

In an embodiment, the method includes, responsive to completion of a data transfer from the source external device to the destination external device in accordance with a first command descriptor, reloading the first command descriptor, fetching a second command descriptor from context memory, or de-allocating the physical channel.

Embodiment of the disclosure also include the following numbered items, which are combinable:

Item 1. A direct memory access controller (DMAC) including a plurality of virtual channels, a virtual channel of the plurality of virtual channels configured to generate a flow control signal for execution of a direct memory access (DMA) command, one or more physical channels, a physical channel of the one or more physical channels including read and write control logic to initiate, responsive to the flow control signal, transfer of data from one or more source addresses in an external source device to one or more destination addresses in an external destination device in accordance with the DMA command, and a context manager. The context manager includes allocation logic configured to arbitrate between allocation requests from the plurality of virtual channels and allocate a physical channel of the one or more physical channels to a selected virtual channel of the plurality of virtual channels, and routing logic configured to route a flow control signal from the selected virtual channel to the allocated physical channel and to route a status signal from the allocated physical channel to the selected virtual channel.

Item 2. The direct memory access controller (DMAC) of item 1, where a virtual channel of the plurality of virtual channels includes one or more channel control registers, programmable by an external device to provide a trigger input, where the virtual channel is configured to generate the flow control signal in response to the trigger input.

Item 3. The direct memory access controller (DMAC) of item 1, where a virtual channel of the plurality of virtual channels includes one or more trigger ports configured to couple to the external source device or the external destination device, and a control finite state machine (FSM) configured to control a direct memory access (DMA) command in the virtual channel responsive to a signal on the one or more trigger ports.

Item 4. The direct memory access controller (DMAC) of item 3, where the control FSM of the virtual channel is further configured to generate the flow control signal based, at least in part, on a signal from a trigger port of the one or more trigger ports.

Item 5. The direct memory access controller (DMAC) of item 3, where the context manager includes de-allocation logic and where the control FSM of the virtual channel is configured to signal the context manager when the virtual channel is in a state where it can be de-allocated by the context manager.

Item 6. The direct memory access controller (DMAC) of item 1, where the context manager is configured to issue a pre-emptive pause request to a lowest priority virtual channel when a higher priority virtual channel cannot access a physical channel due to a lower priority virtual channel being unable to progress its operation, and the lowest priority virtual channel is configured to forward the pre-emptive pause request to the physical channel allocated to it.

Item 7. The direct memory access controller (DMAC) of item 1, where a physical channel of the one or more physical channels includes a command descriptor store configured to store command parameters, command descriptor update logic configured to update one or more of the command parameters stored in the command descriptor store, and a context fetch and save finite state machine (FSM) configured to transfer command parameters between the command descriptor store and a context memory.

Item 8. The direct memory access controller (DMAC) of item 7, where the command parameters include source and destination addresses, source and destination address increments, a data chunk size and a number of pending transfers.

Item 9. The direct memory access controller (DMAC) of item 7, further including a DMA control logic block configured to clear all channel registers related to the execution of a DMA command when a virtual channel is de-allocated, and to generate write commands to clear an associated area in the context memory.

Item 10. The direct memory access controller (DMAC) of item 7, where the context memory is coupled to the DMAC via a bus, the DMAC further including a context bus interface unit coupled to one or more physical channels. The context bus interface unit includes bus arbitration logic configured to arbitrate between bus access requests from multiple physical channels, and transfer generation logic configured to generate bus requests corresponding to requests received from a physical channel.

Item 11. The direct memory access controller (DMAC) of item 1, further including a DMA control logic block including DMAC global control logic, a bus interface configured to exchange configuration data with external hardware, an interface to virtual channel and physical channel configuration registers, and a bridge to the context bus interface unit to enable access to a context memory by the external hardware.

Item 12. The direct memory access controller (DMAC) of item 11, where the DMA control logic block also includes an interrupt controller configured to collect DMA channel status signals from the virtual channels and generate therefrom interrupt signals on associated channels on an interrupt bus.

Item 13. The direct memory access controller (DMAC) of item 1, where the external source device and the external destination device are coupled to the DMAC via a data bus, the DMAC further including a data bus interface unit coupled to one or more physical channels. The data bus interface unit includes bus arbitration logic configured to arbitrate between bus access requests from multiple physical channels, transfer generation logic configured to generate bus requests corresponding to requests received from a physical channel, and a buffer configured to store data read from the external source device and to be written to the external destination device.

Item 14. The direct memory access controller (DMAC) of item 1, where the routing logic of the context manager includes an allocation table maintained by the arbitration logic, each entry in the allocation table corresponding to a physical channel and indicating a virtual channel to which the physical channel is allocated. For each physical channel of the one or more physical channels, a virtual-to-physical multiplexer configured to select a virtual channel of the plurality of virtual channels, in accordance with an entry in the allocation table for the physical channel, and to route a signal from the selected virtual channel to the physical channel. For each physical channel of the one or more physical channels, a physical-to-virtual multiplexer configured to select a virtual channel of the plurality of virtual channels, in accordance with an entry in the allocation table for the physical channel, and to route a signal from the physical channel to the selected virtual channel.

Item 15. A method of data transfer in a data processing system including allocating, by a context manager of the DMAC in response to allocation requests from one or more virtual channels of a plurality of virtual channels of the DMAC, a physical channel of one or more physical channels of the DMAC to a selected virtual channel of the plurality of virtual channels, generating, by the selected virtual channel, a flow control signal, initiating, by a physical channel of one or more physical channels of the DMAC, responsive to the flow control signal, transfer of data from one or more source addresses in an external source device to one or more destination addresses in an external destination device, in accordance with a command descriptor for a DMA channel, routing, by the context manager, the flow control signal from the selected virtual channel to the allocated physical channel, and routing, by the context manager, a status signal from the allocated physical channel to the selected virtual channel.

Item 16. The method of item 15, further including configuring, by external hardware, the command descriptor of the DMA channel.

Item 17. The method of item 15, where the command descriptor includes, as command parameters: source and destination addresses, source and destination address increments, a data chunk size, and a number of data chunks to transfer between an external source device and an external destination device.

Item 18. The method of item 15, where generating the flow control signal by the selected virtual channel is responsive to one or more trigger inputs from the external source device, the external destination device, or both the external source device and the external destination device.

Item 19. The method of item 15, further including clearing channel registers when a designated bit in a header of the command descriptor is set.

Item 20. The method of item 15, where said allocating includes selecting a virtual channel, of the plurality of virtual channels requesting allocation, based, at least in part, on a priority value of the virtual channel, selecting a physical channel of the one or more physical channels that is neither allocated nor in a process of being allocated, and storing an identifier of the selected virtual channel in an entry of an allocation table corresponding to the selected physical channel.

Item 21. The method of item 20, where said routing includes controlling multiplexers of the DMAC in accordance with the entries of the allocation table.

Item 22. The method of item 15, also including, responsive to a change in allocation of a physical channel: saving a current context of the physical channel to a context memory and fetching a new context for the physical channel from the context memory.

Item 23. The method of item 22, where saving or fetching a context includes accessing an external context memory via a bus.

Item 24. The method of item 15, also including, responsive to completion of a data transfer from the source external device to the destination external device in accordance with a first command descriptor: reloading the first command descriptor, loading a second command descriptor, or de-allocating the physical channel.

Item 25. A non-transitory computer-readable medium to store computer-readable code for fabrication of a direct memory access controller (DMAC) including a plurality of virtual channels, a virtual channel of the plurality of virtual channels configured to generate a flow control signal for execution of a direct memory access (DMA) command, one or more physical channels, a physical channel of the one or more physical channels including read and write control logic to initiate, responsive to the flow control signal, transfer of data from a source address in an external source device to a destination address in an external destination device in accordance with the DMA command, and a context manager. The context manager includes allocation logic configured to arbitrate between allocation requests from the plurality of virtual channels and allocate a physical channel of the one or more physical channels to a selected virtual channel of the plurality of virtual channels, and routing logic configured to route a flow control signal from the selected virtual channel to the allocated physical channel and to route a status signal from the allocated physical channel to the selected virtual channel.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or,” as used herein, is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

As used herein, the term “configured to,” when applied to an element, means that the element may be designed or constructed to perform a designated function, or that is has the required structure to enable it to be reconfigured or adapted to perform that function.

Numerous details have been set forth to provide an understanding of the embodiments described herein. The embodiments may be practiced without these details. In other instances, well-known methods, procedures, and components have not been described in detail to avoid obscuring the embodiments described. The disclosure is not to be considered as limited to the scope of the embodiments described herein.

Those skilled in the art will recognize that the present disclosure has been described by means of examples. The present disclosure could be implemented using hardware component equivalents such as special purpose hardware and/or dedicated processors which are equivalents to the present disclosure as described and claimed. Similarly, dedicated processors and/or dedicated hard wired logic may be used to construct alternative equivalent embodiments of the present disclosure.

Dedicated or reconfigurable hardware components used to implement the disclosed mechanisms may be described, for example, by instructions of a hardware description language (HDL), such as VHDL, Verilog or RTL (Register Transfer Language), or by a netlist of components and connectivity. The instructions may be at a functional level or a logical level or a combination thereof. The instructions or netlist may be input to an automated design or fabrication process (sometimes referred to as high-level synthesis) that interprets the instructions and creates digital hardware that implements the described functionality or logic.

The HDL instructions or the netlist may be stored on non-transitory computer readable medium such as Electrically Erasable Programmable Read Only Memory (EEPROM); non-volatile memory (NVM); mass storage such as a hard disc drive, floppy disc drive, optical disc drive; optical storage elements, magnetic storage elements, magneto-optical storage elements, flash memory, core memory and/or other equivalent storage technologies without departing from the present disclosure. Such alternative storage devices should be considered equivalents.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define an HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and System Verilog or other behavioral representations of the concepts that can be interpreted by a computer to enable simulation, functional and/or formal verification, and testing of the concepts.

Additionally, or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively, or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively, or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Various embodiments described herein are implemented using dedicated hardware, configurable hardware or programmed processors executing programming instructions that are broadly described in flow chart form that can be stored on any suitable electronic storage medium or transmitted over any suitable electronic communication medium. A combination of these elements may be used. Those skilled in the art will appreciate that the processes and mechanisms described above can be implemented in any number of variations without departing from the present disclosure. For example, the order of certain operations carried out can often be varied, additional operations can be added, or operations can be deleted, without departing from the present disclosure. Such variations are contemplated and considered equivalent.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

1. A direct memory access controller (DMAC) comprising:
a plurality of virtual channels, a virtual channel of the plurality of virtual channels configured to generate a flow control signal for execution of a direct memory access (DMA) command;
one or more physical channels, a physical channel of the one or more physical channels including read and write control logic to initiate, responsive to the flow control signal, transfer of data from one or more source addresses in an external source device to one or more destination addresses in an external destination device in accordance with the DMA command; and
a context manager including:
allocation logic configured to arbitrate between allocation requests from the plurality of virtual channels and allocate a physical channel of the one or more physical channels to a selected virtual channel of the plurality of virtual channels; and
routing logic configured to route a flow control signal from the selected virtual channel to the allocated physical channel and to route a status signal from the allocated physical channel to the selected virtual channel.

2. The direct memory access controller (DMAC) of claim 1, where a virtual channel of the plurality of virtual channels includes:
one or more channel control registers, programmable by an external device to provide a trigger input,
where the virtual channel is configured to generate the flow control signal in response to the trigger input.

3. The direct memory access controller (DMAC) of claim 1, where a virtual channel of the plurality of virtual channels includes:
one or more trigger ports configured to couple to the external source device or the external destination device; and
a control finite state machine (FSM) configured to control a direct memory access (DMA) command in the virtual channel responsive to a signal on the one or more trigger ports.

4. The direct memory access controller (DMAC) of claim 3, where the control FSM of the virtual channel is further configured to generate the flow control signal based, at least in part, on a signal from a trigger port of the one or more trigger ports or where the context manager includes de-allocation logic and where the control FSM of the virtual channel is configured to signal the context manager when the virtual channel is in a state where it can be de-allocated by the context manager.

5. (canceled)

6. The direct memory access controller (DMAC) of claim 1, where:
the context manager is configured to issue a pre-emptive pause request to a lowest priority virtual channel when a higher priority virtual channel cannot access a physical channel due to a lower priority virtual channel being unable to progress its operation; and
the lowest priority virtual channel is configured to forward the pre-emptive pause request to the physical channel allocated to it.

7. The direct memory access controller (DMAC) of claim 1, where a physical channel of the one or more physical channels includes:
a command descriptor store configured to store command parameters;
command descriptor update logic configured to update one or more of the command parameters stored in the command descriptor store; and
a context fetch and save finite state machine (FSM) configured to transfer command parameters between the command descriptor store and a context memory.

8. The direct memory access controller (DMAC) of claim 7, where the command parameters include source and destination addresses, source and destination address increments, a data chunk size and a number of pending transfers.

9. The direct memory access controller (DMAC) of claim 7, further comprising one or more of:
a DMA control logic block configured to:
clear all channel registers related to the execution of a DMA command when a virtual channel is de-allocated; and
generate write commands to clear an associated area in the context memory, and
where the context memory is coupled to the DMAC via a bus, the DMAC further comprising a context bus interface unit coupled to one or more physical channels, the context bus interface unit including:
bus arbitration logic configured to arbitrate between bus access requests from multiple physical channels; and
transfer generation logic configured to generate bus requests corresponding to requests received from a physical channel.

10. (canceled)

11. The direct memory access controller (DMAC) of claim 1, further comprising a DMA control logic block including:
DMAC global control logic;
a bus interface configured to exchange configuration data with external hardware;
an interface to virtual channel and physical channel configuration registers; and
a bridge to a context bus interface unit to enable access to a context memory by the external hardware.

12. The direct memory access controller (DMAC) of claim 11, where the DMA control logic block also includes an interrupt controller configured to collect DMA channel status signals from the virtual channels and generate therefrom interrupt signals on associated channels on an interrupt bus.

13. The direct memory access controller (DMAC) of claim 1, where the external source device and the external destination device are coupled to the DMAC via a data bus, the DMAC further comprising a data bus interface unit coupled to one or more physical channels, the data bus interface unit including:
bus arbitration logic configured to arbitrate between bus access requests from multiple physical channels;
transfer generation logic configured to generate bus requests corresponding to requests received from a physical channel; and
a buffer configured to store data read from the external source device and to be written to the external destination device.

14. The direct memory access controller (DMAC) of claim 1, where the routing logic of the context manager includes:
an allocation table maintained by the arbitration logic, each entry in the allocation table corresponding to a physical channel and indicating a virtual channel to which the physical channel is allocated;
for each physical channel of the one or more physical channels, a virtual-to-physical multiplexer configured to select a virtual channel of the plurality of virtual channels, in accordance with an entry in the allocation table for the physical channel, and route a signal from the selected virtual channel to the physical channel; and
for each physical channel of the one or more physical channels, a physical-to-virtual multiplexer configured to select a virtual channel of the plurality of virtual channels, in accordance with an entry in the allocation table for the physical channel, and route a signal from the physical channel to the selected virtual channel.

15. A method of data transfer in a data processing system comprising:
allocating, by a context manager of a direct memory access controller (DMAC) in response to allocation requests from one or more virtual channels of a plurality of virtual channels of the DMAC, a physical channel of one or more physical channels of the DMAC to a selected virtual channel of the plurality of virtual channels; and
generating, by the selected virtual channel, a flow control signal;
initiating, by a physical channel of one or more physical channels of the DMAC, responsive to the flow control signal, transfer of data from one or more source addresses in an external source device to one or more destination addresses in an external destination device, in accordance with a command descriptor for a DMA channel;
routing, by the context manager, the flow control signal from the selected virtual channel to the allocated physical channel; and
routing, by the context manager, a status signal from the allocated physical channel to the selected virtual channel.

16. The method of claim 15, further comprising one or more of:
configuring, by external hardware, the command descriptor of the DMA channel; and
clearing channel registers when a designated bit in a header of the command descriptor is set.

17. The method of claim 15, where the command descriptor includes, as command parameters:
source and destination addresses;
source and destination address increments;
a data chunk size; and
a number of data chunks to transfer between an external source device and an external destination device.

18. The method of claim 15, where generating the flow control signal by the selected virtual channel is responsive to one or more trigger inputs from the external source device, the external destination device, or both the external source device and the external destination device.

19. (canceled)

20. The method of claim 15, where said allocating includes:
selecting a virtual channel, of the plurality of virtual channels requesting allocation, based, at least in part, on a priority value of the virtual channel;
selecting a physical channel of the one or more physical channels that is neither allocated nor in a process of being allocated; and
storing an identifier of the selected virtual channel in an entry of an allocation table corresponding to the selected physical channel.

21. The method of claim 20, where said routing includes controlling multiplexers of the DMAC in accordance with the entries of the allocation table.

22. The method of claim 15, further comprising one or more of:
responsive to a change in allocation of a physical channel:
saving a current context of the physical channel to a context memory; and
fetching a new context for the physical channel from the context memory, and
responsive to completion of a data transfer from the source external device to the destination external device in accordance with a first command descriptor:
reloading the first command descriptor;
loading a second command descriptor; or
de-allocating the physical channel.

23. The method of claim 22, where saving or fetching a context includes accessing an external context memory via a bus.

24. (canceled)

25. A non-transitory computer-readable medium to store computer-readable code for fabrication of a direct memory access controller (DMAC) comprising:
a plurality of virtual channels, a virtual channel of the plurality of virtual channels configured to generate a flow control signal for execution of a direct memory access (DMA) command;
one or more physical channels, a physical channel of the one or more physical channels including read and write control logic to initiate, responsive to the flow control signal, transfer of data from a source address in an external source device to a destination address in an external destination device in accordance with the DMA command; and
a context manager including:
allocation logic configured to arbitrate between allocation requests from the plurality of virtual channels and allocate a physical channel of the one or more physical channels to a selected virtual channel of the plurality of virtual channels; and
routing logic configured to route a flow control signal from the selected virtual channel to the allocated physical channel and to route a status signal from the allocated physical channel to the selected virtual channel.
